(19) United States
(12) Patent Application Publication
(10) Pub. No.: US 2025/0130864 A1
(43) Pub. Date: Apr. 24, 2025

(54) SCORE BASED METHOD TO DETERMINE APPLICATION LOAD FOR AUTO-SCALING AND REBALANCING IN CONTAINER-BASED CLUSTERS

(71) Applicant: VMware, Inc., Palo Alto, CA (US)

(72) Inventors: Sudipta BISWAS, Bangalore (IN); Monotosh DAS, Bangalore (IN); Kavita CHAWLA, Pune (IN); Ayush GUPTA, Indore (IN)

(21) Appl. No.: 18/489,793

(22) Filed: Oct. 18, 2023

(51) Int. Cl. G06F 9/50; G06F 9/54

(52) U.S. Cl. CPC G06F 9/505; G06F 9/5083; G06F 9/542

(57) ABSTRACT

The disclosure provides a method for assigning new load to an application instance in a public cloud. The method generally includes calculating, for each application instance of a plurality of application instances running in the public cloud, a respective resource utilization score, wherein for each application instance: the respective score is calculated by applying, for each of two or more resource utilization metrics associated with the application instance, a respective weight to a respective resource usage value for the resource utilization metric, and wherein, for each of the two or more resource utilization metrics, the respective weight is a function of the respective resource usage values for the two or more resource utilization metrics; identifying an application instance having a highest respective score among the respective scores calculated for the application instances; and determining whether the application instance having the highest respective score is capable of handling the new load.

Modern applications are applications designed to take advantage of the benefits of modern computing platforms and infrastructure. For example, modern applications can be deployed in a multi-cloud or hybrid cloud fashion. A multi-cloud application may be deployed across multiple clouds, which may be multiple public clouds provided by different cloud providers or the same cloud provider or a mix of public and private clouds. The term, “private cloud” refers to one or more on-premises data centers that may have pooled resources allocated in a cloud-like manner. Hybrid cloud refers specifically to a combination of public cloud and private clouds. Thus, an application deployed across a hybrid cloud environment consumes both cloud services executing in a public cloud and local services executing in a private data center (e.g., a private cloud).

Within each public cloud or private datacenter, modern applications can be deployed onto one or more virtual machines (VMs), containers, and/or the like. A container is a package that relies on virtual isolation to deploy and run applications that depend on a shared operating system (OS) kernel. Containerized applications (also referred to as “containerized workloads”), can include a collection of one or more related applications packaged into one or more containers. In some orchestration systems, a set of one or more related containers sharing storage and network resources, referred to as a pod, are deployed as a unit of computing software. Container orchestration systems automate the lifecycle of containers, including such operations as provisioning, deployment, monitoring, scaling (up and down), networking, and load balancing.

Kubernetes® (K8S®) software is an example open-source container orchestration platform that automates the operation of such containerized applications. In particular, Kubernetes may be used to create a cluster of interconnected nodes, including (1) one or more worker nodes that run the containerized applications (e.g., in a worker plane) and (2) one or more control plane nodes (e.g., in a control plane) having control plane components running thereon that control the cluster. Control plane components make global decisions about the cluster (e.g., scheduling), and can detect and respond to cluster events (e.g., starting up a new pod when a workload deployment's intended replication is unsatisfied, etc.). As used herein, a node may be a physical machine, or a VM configured to run on a physical machine running a hypervisor. Kubernetes software allows for distributed computing by running the pods of containerized workloads on a cluster of interconnected worker nodes (e.g., VMs or physical machines) that may scale vertically and/or horizontally over hybrid cloud topology.

Multi-cloud infrastructure offers many benefits, including the ability to scale quickly and/or increase reliability across applications. However, deploying, managing servicing, and securing diverse application in different clouds, often both private and public, results in operationally and technologically complex infrastructure. In particular, traditional network architecture may be distributed across private and public clouds with multiple applications running on multiple clouds, each using a different set of networking features, security rules, and automation policies. Each cloud may also be managed by individual local users through native cloud consoles, making the adoption of unified policies across the multi-cloud environment difficult. This poses operational challenges and adds complexities to managing applications and data in hybrid and multi-cloud infrastructure. Further, this decentralized network infrastructure may require users to deploy complex security rules to protect lateral network traffic (e.g., across clouds) while having to rely on limited application mobility, visibility, and threat detection capabilities that may not scale in multi-cloud environments.

As such, more recently, Software-as-a-Service (SaaS)-based networking and security offerings have been developed, to overcome the technical challenges of traditional network architecture and tools. A SaaS platform is a software distribution platform in which a software provider hosts cloud-based services, such as cloud-based network and security services, and makes them available to end users over the Internet. An example SaaS-based networking and security offering includes Project Northstar made commercially available by VMware, Inc. of Palo Alto, CA. SaaS-based networking and security provides a set of on-demand multi-cloud networking and security services, end-to-end visibility, and network communication controls. SaaS-based networking and security helps to relieve users from the burden of using a different set of networking features (e.g., management, security, automation of operations, etc.) available in every private and/or public cloud, by providing a SaaS service that enables consistent policy, operations, and automation across multi-cloud environments. Further, by accessing a cloud console, users are able to apply networking and security policies across multi-cloud environments.

SaaS-based networking and security offers a variety of services to a user including (1) security planning and visibility by providing a 360-degree, real-time view of a user's multi-cloud environment, (2) scalable threat detection and response for applications deployed across various clouds, (3) advanced load balancing services across private data centers, private clouds, and/or public clouds, and (4) an ability to handle workload migration and rebalancing activities centrally across multiple clouds. Further, users are able to deploy and manage consistent networking and security controls and policies across multi-site and multi-region deployments.

A portion of a SaaS-based networking and security platform may run in one or more local (on premise) datacenters (e.g., such as software-defined data center(s) (SDDC(s))), while a majority of the SaaS networking and security services may run in a public cloud. In some cases, the cloud-based SaaS networking and security services need to execute commands on each private datacenter to retrieve information and/or persist states. However, due to operational constraints (e.g., primarily associated with firewalls), the local data centers may not be directly routable from the public cloud.

As such, in some cases, a Hypertext Transfer Protocol (HTTP)/2 server is implemented (e.g., as an application) in the cloud to create a connection between a local datacenter and the public cloud to enable the SaaS networking and security services running in the public cloud to push messages and execute commands on the local data center. In particular, the local datacenter may register itself with and initiate a transmission control protocol (TCP) connection to the HTTP/2 server. HTTP/2 provides connection multiplexing and server push mechanisms on the same TCP channel (e.g., send multiple requests and receive multiple responses “bundled” into a single TCP connection). Accordingly, inside the TCP connection established between the HTTP/2 server and the private datacenter, an HTTP/2 server push may be initiated to send messages to a connected datacenter. The HTTP/2 server push may include the payload which is intended to be executed on the receiving datacenter.

Multiple instances of HTTP/2 servers may be deployed in the cloud to provide a scalable and resilient solution for SaaS-based networking and security offerings. Each HTTP/2 server may be deployed and running in a pod in the cloud. Further, each HTTP/2 server may have one or more connections with local datacenters accessing the SaaS networking and security services provided in the public cloud. A maximum number of connections (e.g., each between an HTTP/2 server and a local datacenter) that a given HTTP/2 server can hold may be a function of the number of transactions happening over each datacenter connection. A number of connections created between HTTP/2 servers and datacenters, as well as the number of transactions on each of these connections, may vary over time, however. In other words, load for a single HTTP/2 server and/or amongst multiple HTTP/2 servers may constantly change.

It should be noted that the information included in the Background section herein is simply meant to provide a reference for the discussion of certain embodiments in the Detailed Description. None of the information included in this Background should be considered as an admission of prior art.

### SUMMARY

One or more embodiments provide a method for assigning new load to an application instance in a public cloud. The method generally includes calculating, for each application instance of a plurality of application instances running in the public cloud, a respective resource utilization score. For each application instance, the respective resource utilization score is calculated by applying, for each of two or more resource utilization metrics associated with the application instance, a respective weight to a respective resource usage value for the resource utilization metric. For each of the two or more resource utilization metrics, the respective weight is a function of the respective resource usage values for the two or more resource utilization metrics. Further, the method generally includes identifying an application instance having a highest respective resource utilization score among the respective resource utilization scores calculated for the plurality of application instances. The method generally includes determining whether the application instance having the highest respective resource utilization score is capable of handling the new load. When the application instance is capable of handing the new load: the method generally includes assigning the new load to the application instance. Alternatively, when the application instance is not capable of handing the new load: the method generally includes provisioning a new application instance in the public cloud and assigning the new load to the new application instance.

Further embodiments include one or more non-transitory computer-readable storage media comprising instructions that, when executed by one or more processors of a computing system, cause the computer system to carry out the above methods, as well as a computer system comprising one or more memories and one or more processors configured to carry out the above methods.

### BRIEF DESCRIPTION OF THE DRAWINGS

FIG. 1A illustrates a computing system in which embodiments described herein may be implemented.

FIG. 1B illustrates an example container-based cluster for running containerized applications in the computing system of FIG. 1A, according to an example embodiment of the present disclosure.

FIG. 2 illustrates an example system for providing Software-as-a-Service (SaaS)-based networking and security services, according to an example embodiment of the present disclosure.

FIG. 3 illustrates an example method for assigning a new datacenter connection to a Hypertext Transfer Protocol (HTTP)/2 server instance, according to an example embodiment of the present disclosure.

FIG. 4 is a graph illustrating an example relationship between a first resource metric and a resource utilization score, according to an example embodiment of the present disclosure.

FIG. 5 illustrates an example method for re-distributing load across HTTP/2 server instances, according to an example embodiment of the present disclosure.

FIG. 6 illustrates an example method for assigning new load to an application instance in a public cloud, according to an example embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

To account for changes in the number of datacenter connections and/or transactions per datacenter connection over time, a horizontal pod autoscaler (HPA) may be used. This autoscaler is designed to help guarantee availability in container-based clusters (e.g., such as Kubernetes) by providing automatic horizontal scalability of application resources to adapt to varying load. Horizontal scaling refers to the process of deploying additional pods in a cluster (e.g., to increase application instances running therein) in response to increased load and/or removing pods in the container-based cluster (e.g., to decrease application instances running therein) in response to decreased load. In some cases, the HPA is designed to automatically increase and/or decrease the number of pods (e.g., pod replicas), and thus HTTP/2 servers running in these pods, in the cluster based on actual usage metrics, such as central processing unit (CPU) and/or memory utilization of the existing pods.

For example, in certain embodiments, the HPA is implemented as a control loop to scale pods and HTTP/2 server instances based on the comparison between desired metric values and current metric values. The current metric values may be based on average load amongst a set of pods running HTTP/2 servers as opposed to looking at individual HTTP/2 server performance. Thus, one HTTP/2 server with increased load may cause an average load calculated for multiple HTTP/2 servers to increase, and in some cases, increase to a value above a desired metric value (e.g., actual average CPU usage>desired average CPU usage) such that the HPA determines to instantiate a new pod for running an additional HTTP/2 server instance. Instantiation of a new pod and an HTTP/2 server instance may unnecessarily increase resource usage and thus, runtime cost, in cases where one or more other existing HTTP/2 servers may have had capacity for handling the excess load on the HTTP/2 server. In other words, in this case, redistribution of the load across existing HTTP/2 servers (and pod instances), instead of scaling up the number of HTTP/2 instances, would have solved the problem more efficiently and without increasing runtime cost. Unfortunately, however, the average metrics calculation used to determine the resource provisioning strategy does not allow for automatic re-balancing of load amongst the pods prior to instantiating a new pod for a new HTTP/2 server instance.

Further, when a new datacenter attempts to register itself with and initiate a TCP connection to an existing HTTP/2 server (e.g., to use SaaS-based networking and security services offered in the public cloud), connection of the datacenter to a least loaded HTTP/2 server is desired to help achieve optimum utilization of resources. Some methods for calculating the load of each HTTP/2 server include calculating an average resource utilization for the server based on CPU utilization, memory usage, throughput of the network, and/or the like. For example, an average resource utilization calculated for an HTTP/2 server utilizing 90% of its allocated CPU and 20% of its allocated memory may be equal to 65% (e.g., (90%+20%)/2=55%). An HTTP/2 server with a lowest calculated resource utilization, using the calculation above, may be selected to form a connection with the new datacenter.

Unfortunately, such methods of calculating resource utilization based on an average of multiple metrics, when identifying an HTTP/2 server for a new datacenter connection, fail to consider the possibility of different weights for different metrics. Instead, CPU utilization, memory utilization, etc. are weighted equally when calculating HTTP/2 server instance resource utilization. This becomes especially problematic in cases where one metric is high, while other metrics used to calculate the average resource utilization for an HTTP/2 server instance are low. In particular, the lower valued metrics may reduce the calculated average, thereby making the HTTP/2 server instance appear to be less utilized and a “good” candidate for the new datacenter connection. However, the HTTP/2 server instance may not be a desirable candidate due to the single high value metric, given high valued metrics often indicate that the HTTP/2 server instance cannot, in fact, handle any new connections. For example, as described above, the average resource utilization calculated for an HTTP/2 server with 90% CPU usage and 20% memory usage is 55%. Although the average utilization portrays the HTTP/2 server as being only 55% loaded, it is unlikely that this HTTP/2 server is able to handle an additional datacenter connection due to the small amount of available CPU resources at the HTTP/2 server. Accordingly, improved methods (1) for calculating HTTP/2 server instance resource utilization and (2) for determining when and how to re-distribute load across existing HTTP/2 server instances are desired.

Techniques for performing auto-scaling and auto-re-balancing in container-based clusters are described herein.

Auto-scaling may involve dynamically scaling Hypertext Transfer Protocol (HTTP)/2 servers deployed as pods (e.g., a number of pods) up and/or down based on changes in application load (e.g., HTTP/2 server(s) load) in a container-based cluster. For example, application load may increase when a number of datacenter connections that need to be assigned to an HTTP/2 server in a container-based cluster, offering Software-as-a-Service (SaaS)-based networking and security services in a public cloud, increases (e.g., due to the addition of a new datacenter). In some cases, this increase in application load warrants the provisioning of a new HTTP/2 server in the cluster to handle the load (e.g., scaling up); however, in some other cases, the additional load may be handled by HTTP/2 servers currently deployed in the cluster. To determine whether the provisioning of extra resources (e.g., an HTTP/2 server) is justified, embodiments described herein determine a runtime state of each HTTP/2 server running in the cluster and further verify whether or not the runtime state of at least one HTTP/2 server indicates that the HTTP/2 server is capable of handling load of the new datacenter (e.g., capable of handling a plurality of transactions occurring over another connection with the new datacenter).

In particular, when a new datacenter connection needs to be assigned to a HTTP/2 server in the cluster, a resource utilization score may be determined for each HTTP/2 server currently deployed and running in the cluster. The resource utilization score calculated for an HTTP/2 server may apply different weights (e.g., coefficients) to resource usage values of various utilization metrics (e.g., central processing unit (CPU) utilization, memory usage, throughput etc.) associated with the HTTP/2 server. More specifically, calculating the resource utilization score for an HTTP/2 server may include (1) calculating a difference between 100 and each resource usage value of various utilization metrics associated with the HTTP/2 server and (2) applying different weights to each difference calculated for each resource usage value (e.g., [first weight*(100−first resource usage value)], [second weight*(100−second resource usage value)], etc.). In some cases, a larger weight is applied to a larger resource usage value than a smaller resource usage value (e.g., a larger weight may be applied to a CPU utilization of 80% than a CPU utilization of 20%). An HTTP/2 server having a resource utilization score greater than a resource utilization score calculated for other HTTP/2 servers deployed in the cluster may be selected as a potential candidate for hosting the new datacenter connection. In cases where the selected HTTP/2 server is capable of handling the new datacenter connection, then provisioning additional resources (e.g., an HTTP/2 server deployed as a new pod) may be avoided, thereby reducing runtime costs in the cluster for providing SaaS-based networking and security services. Alternatively, a new HTTP/2 server may be automatically deployed as a new pod in the cluster where the selected HTTP/2 server is determined to be incapable of handling the load of the new datacenter connection.

Auto-re-balancing may involve dynamically re-distributing load across HTTP/2 servers deployed as pods in a container-based cluster. For example, due to asymmetric distribution of HTTP/2 server load (e.g., datacenter connections to HTTP/2 servers), one or more HTTP/2 servers may experience high resource usage (e.g., calculated using the resource utilization score described above), while resource usage of other HTTP/2 servers is relatively low. In such cases, auto-re-balancing techniques may be used to automatically re-distribute datacenter connections mapped to heavily loaded (e.g., high resource usage) HTTP/2 servers to other HTTP/2 servers. In some cases, a minimum number of adjustments may be performed to re-distribute one or more datacenter connections to help reduce resource consumption associated with these re-distribution efforts. Such redistribution may be used to help achieve even distribution of load across HTTP/2 servers. Maintaining an even distribution of load across HTTP/2 servers may help to avoid provisioning new HTTP/2 servers when load increases (e.g., due to new datacenter connections). In other words, re-distributing load automatically at runtime amongst already provisioned instances of HTTP/2 servers in the cluster may reduce the need to scale out HTTP/2 servers/pods in the container-based cluster to account for increases in load.

The techniques described herein for performing auto-scaling and auto-rebalancing in container-based clusters provide significant technical advantages over other solutions, such as reduced runtime costs by limiting the provisioning of additional resources (e.g., HTTP/2 servers deployed as pods) to cases where resource utilization across existing HTTP/2 servers is high and a new HTTP/2 server is needed to handle increased load in the cluster. Further, the techniques described herein provide improved methods for calculating a resource utilization of an HTTP/2 server by allowing for different weights to be applied to different resource usage values. As such, a resource utilization score calculated for the HTTP/2 server may better represent the runtime state of the HTTP/2 server, given very low and/or very high resource usage values for one or more resource utilization metrics is less likely to skew the calculated score due to the difference in weights applied in the calculation.

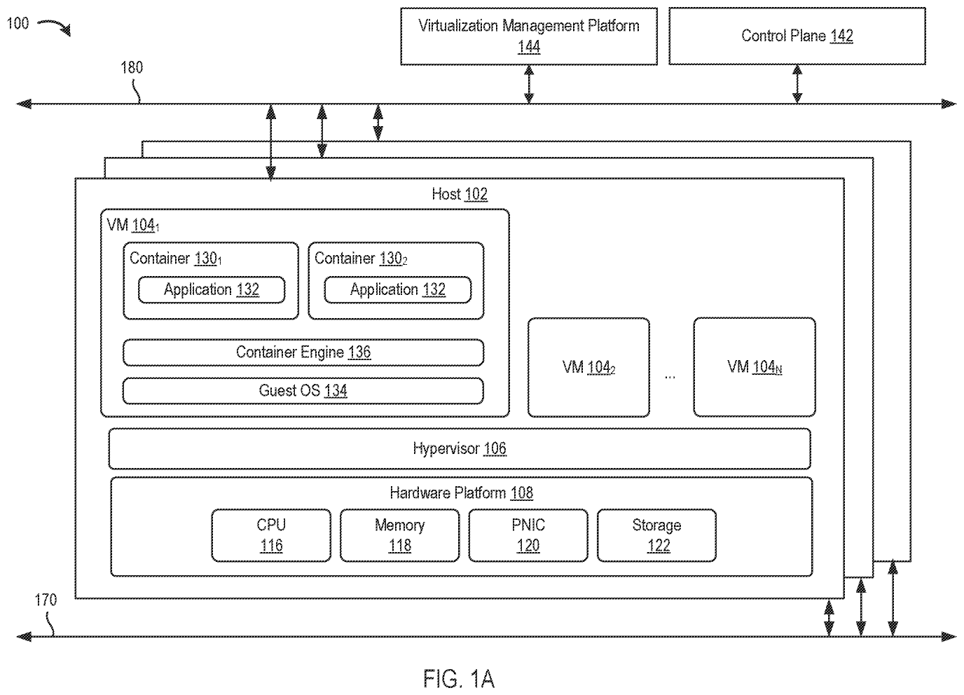

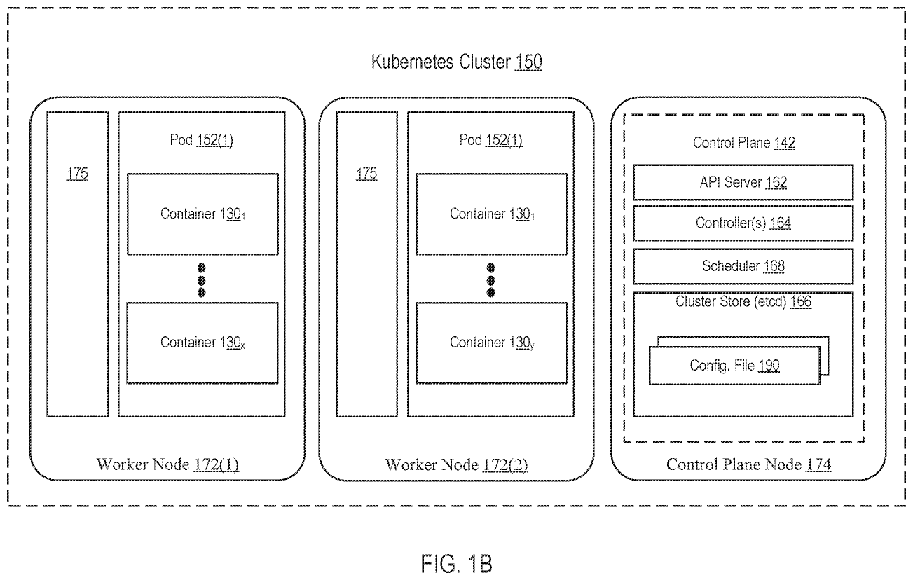

FIG. 1A is a block diagram that illustrates a computing system 100 in which embodiments described herein may be implemented. Computing system 100 includes one or more hosts 102, a management network 180, a data network 170, a virtualization management platform 144, and in certain embodiments, a control plane 142.

Host(s) 102 may be geographically co-located servers on the same rack or on different racks in any arbitrary location in the data center. Host(s) 102 may be in a single host cluster or logically divided into a plurality of host clusters. Each host 102 may be configured to provide a virtualization layer, also referred to as a hypervisor 106, that abstracts processor, memory, storage, and networking resources of a hardware platform 108 of each host 102 into multiple VMs 104₁ to 104_{N} (collectively referred to as VMs 104 and individually referred to as VM 104) that run concurrently on the same host 102.

Host(s) 102 may be constructed on a server grade hardware platform 108, such as an x86 architecture platform. Hardware platform 108 of each host 102 includes components of a computing device such as one or more processors (central processing units (CPUs)) 116, memory (random access memory (RAM)) 118, one or more network interfaces (e.g., physical network interfaces (PNICs) 120), storage 122, and other components (not shown). CPU 116 is configured to execute instructions that may be stored in memory 118, and optionally in storage 122. The network interface(s) enable hosts 102 to communicate with other devices via a physical network, such as management network 180 and data network 170.

In certain embodiments, hypervisor 106 runs in conjunction with an operating system (OS) (not shown) in host 102. In some embodiments, hypervisor 106 can be installed as system level software directly on hardware platform 108 of host 102 (often referred to as “bare metal” installation) and be conceptually interposed between the physical hardware and the guest OSs executing in the VMs 104. It is noted that the term “operating system,” as used herein, may refer to a hypervisor. One example of hypervisor 106 that may be configured and used in embodiments described herein is a VMware ESXi™ hypervisor provided as part of the VMware vSphere® solution made commercially available by VMware, Inc. of Palo Alto, CA.

Each of VMs 104 implements a virtual hardware platform that supports the installation of a guest OS 134 which is capable of executing one or more applications 132. Guest OS 134 may be a standard, commodity operating system. Examples of a guest OS include Microsoft Windows, Linux, and/or the like. Applications 132 may be any software program, such as a word processing program.

Virtualization management platform 144 is a computer program that executes in a host 102, or alternatively, runs in one of VMs 104. Virtualization management platform 144 is configured to carry out administrative tasks for computing system 100, including managing hosts 102, managing (e.g., configuring, starting, stopping, suspending, etc.) VMs 104 running within each host 102, provisioning VMs 104, transferring VMs 104 from one host 102 to another host 102, and/or the like.

In certain embodiments, computing system 100 includes a container orchestrator. The container orchestrator implements a container orchestration control plane (also referred to herein as the “control plane 142”), such as a Kubernetes control plane, to deploy and manage applications 132 and/or services thereof on hosts 102 using containers 130. In particular, each VM 104 includes a container engine 136 installed therein and running as a guest application under control of guest OS 134. Container engine 136 is a process that enables the deployment and management of virtual instances, referred to herein as “containers,” in conjunction with OS-level virtualization on guest OS 134 within VM 104 and the container orchestrator. Containers 130 provide isolation for user-space processes executing within them. Containers 130 encapsulate an application (and its associated applications 132) as a single executable package of software that bundles application code together with all of the related configuration files, libraries, and dependencies required for it to run.

Control plane 142 runs on a cluster of hosts 102 and may deploy containerized applications 132 as containers 130 on the cluster of hosts 102. Control plane 142 manages the computation, storage, and memory resources to run containers 130 in the host cluster. In certain embodiments, hypervisor 106 is integrated with control plane 142 to provide a “supervisor cluster” (i.e., management cluster) that uses VMs 104 to implement both control plane nodes and compute objects managed by the Kubernetes control plane.

In certain embodiments, control plane 142 deploys and manages applications as pods of containers 130 running on hosts 102, either within VMs 104 or directly on an OS of hosts 102. A pod is a group of one or more containers 130 and a specification for how to run the containers 130. A pod may be the smallest deployable unit of computing that can be created and managed by control plane 142.

An example container-based cluster for running containerized applications is illustrated in FIG. 1B. While the example container-based cluster shown in FIG. 1B is a Kubernetes cluster 150, in other examples, the container-based cluster may be another type of container-based cluster based on container technology, such as Docker Swarm clusters. As illustrated in FIG. 1B, Kubernetes cluster 150 is formed from a cluster of interconnected nodes, including (1) one or more worker nodes 172 that run one or more pods 152 having containers 130 and (2) one or more control plane nodes 174 having control plane components running thereon that control the cluster (e.g., where a node is a physical machine, such as a host 102, or a VM 104 configured to run on a host 102).

Each worker node 172 includes a kubelet 175. Kubelet 175 is an agent that helps to ensure that one or more pods 152 run on each worker node 172 according to a defined state for the pods 152, such as defined in a configuration file. Each pod 152 may include one or more containers 130. The worker nodes 172 can be used to execute various applications 132 and software processes using containers 130. Further, each worker node 172 may include a kube proxy (not illustrated in FIG. 1B). A kube proxy is a network proxy used to maintain network rules. These network rules allow for network communication with pods 152 from network sessions inside and/or outside of Kubernetes cluster 150.

Control plane 142 (e.g., running on one or more control plane nodes 174) includes components such as an application programming interface (API) server 162, controller(s) 164, a cluster store (etcd) 166, and scheduler(s) 168. Control plane 142's components make global decisions about Kubernetes cluster 150 (e.g., scheduling), as well as detect and respond to cluster events.

API server 162 operates as a gateway to Kubernetes cluster 150. As such, a command line interface, web user interface, users, and/or services communicate with Kubernetes cluster 150 through API server 162. One example of a Kubernetes API server 162 is kube-apiserver. The kube-apiserver is designed to scale horizontally—that is, this component scales by deploying more instances. Several instances of kube-apiserver may be run, and traffic may be balanced between those instances.

Controller(s) 164 is responsible for running and managing controller processes in Kubernetes cluster 150. As described above, control plane 142 may have (e.g., four) control loops called controller processes, which watch the state of Kubernetes cluster 150 and try to modify the current state of Kubernetes cluster 150 to match an intended state of Kubernetes cluster 150.

Scheduler(s) 168 is configured to allocate new pods 152 to worker nodes 172.

Cluster store (etcd) 166 is a data store, such as a consistent and highly-available key value store, used as a backing store for Kubernetes cluster 150 data. In certain embodiments, cluster store (etcd) 166 stores configuration file(s) 190, such as JavaScript Object Notation (JSON) or YAML files, made up of one or more manifests that declare intended system infrastructure and applications (e.g., workloads) to be deployed in Kubernetes cluster 150. Kubernetes objects, or persistent entities, can be created, updated and deleted based on configuration file(s) 190 to represent the state of Kubernetes cluster 150.

A Kubernetes object is a “record of intent”—once an object is created, the Kubernetes system will constantly work to ensure that object is realized in the deployment. One type of Kubernetes object is a custom resource definition (CRD) object (also referred to herein as a “custom resource (CR)”) that extends API server 162 or allows a user to introduce their own API into Kubernetes cluster 150. In particular, Kubernetes provides a standard extension mechanism, referred to as custom resource definitions, that enables extension of the set of resources and objects that can be managed in a Kubernetes cluster.

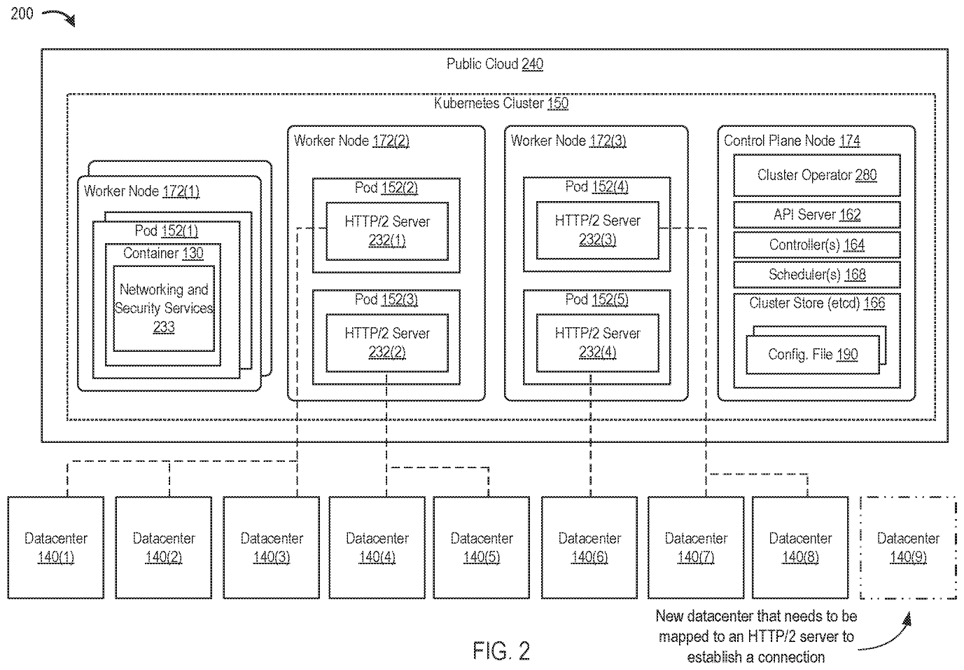

In some cases, container-based architecture, such as Kubernetes cluster 150 described above with respect to FIG. 1B, is used to run multi-cloud networking and security services provided as part of a SaaS-based offering (e.g., such as Project Northstar made available by made commercially available by VMware, Inc. of Palo Alto, CA). FIG. 2 illustrates example container-based architecture 200 for providing SaaS-based networking and security services, according to an example embodiment of the present disclosure.

As illustrated in FIG. 2, a Kubernetes cluster 150 having one or more worker nodes 172 and at least one control plane node 174 is instantiated in a public cloud 240. Public cloud 240 is a third-party managed platform that uses a standard cloud computing model to make resources and/or services available to remote users. Services can include an array of applications including databases, firewalls, load balancers, management tools, and/or other platform-as-a-service (PaaS) or SaaS elements. In this example, services include multi-cloud SaaS-based networking and security services 233 (simply referred to as “networking and security services 233”) deployed onto one or more containers 130 (e.g., belonging to one or more pods 152). Networking and security services 233 may enable users to deploy and manage consistent networking and security controls and policies across multi-site deployments.

Kubernetes cluster 150 further includes one or more HTTP/2 servers 232 (e.g., HTTP/2 servers 232(1)-(4)) running as one or more pods 152 (e.g., pods 152(2)-(4)) on one or more workers nodes 172 (e.g., worker nodes 172(2)-(3)). Each HTTP/2 server 232 is implemented in public cloud 240 to create a connection (e.g., a TCP connection) between a private datacenter 140 (e.g., such as datacenters 140(1)-(9)) and the cloud (illustrated in FIG. 2 as dashed lines). A connection between an HTTP/2 server 232 and each datacenter 140 enables networking and security services 233 to push messages and execute commands on each datacenter 140.

Each datacenter 140 may be an SDDC. Unlike a traditional data center, in an SDDC, infrastructure elements are virtualized. Networking, storage, processing, and security functions can execute as virtualized components on top of physical hardware devices, for example, as illustrated in FIG. 1A.

Each HTTP/2 server 232 may have connections with one or more datacenters 140 accessing networking and security services 233 provided in public cloud 240. However, a maximum number of connections established between an HTTP/2 server 232 and datacenter(s) 140 may depend on the resources allocated to the HTTP/2 server 232 and a number of transactions happening over each connection. A number of connections created between HTTP/2 servers 232 and datacenters 140, as well as the number of transactions on each of these connections, may consistently change over time.

In this example, HTTP/2 server 232(1) is handling three connections, HTTP/2 server 232(2) is handling two connections, and HTTP/2 server 232(3) is handling two connections, and HTTP/2 server 232(4) is handling one connection. More specifically, there exists three connections between HTTP/2 server 232(1) and datacenters 140(1)-(3), two connections between HTTP/2 server 232(2) and datacenters 140(4)-(5), two connections between HTTP/2 server 232(3) and datacenters 140(7)-(8), and one connection between HTTP/2 server 232(4) and datacenter 140(6).

Control plane node 174 of Kubernetes cluster 150 includes an API server 162, controller(s) 164, scheduler(s) 168, and a cluster store (etcd) 166 having one or more configuration files 190, similar to control plane node 174 of Kubernetes cluster 150 described above with respect to FIG. 2. However, control plane node 174 further includes cluster operator 280. Cluster operator 280 is an application-specific controller that extends the functionality of the Kubernetes API to manage HTTP/2 servers 232.

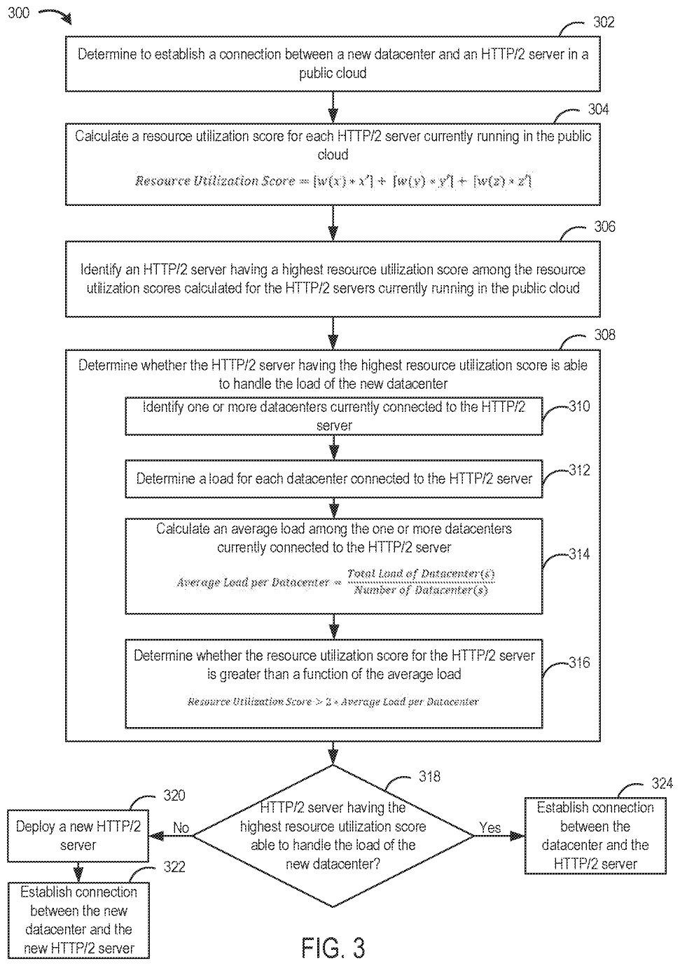

According to embodiments described herein, cluster operator 280 may be configured to assign datacenter 140 connections to various HTTP/2 servers 232, including new datacenters 140 added and newly registered with control plane node 174. In some cases, cluster operator 280 is configured to assign a new datacenter 140 (e.g., such as datacenter 140(9) in FIG. 2) to an HTTP/2 server 232 deployed in public cloud 240 (1) based on a resource utilization score calculated for the HTTP/2 server 232 being greater than a resource utilization score calculated for other HTTP/2 servers 232 deployed in public cloud 240 and (2) based on verifying that the HTTP/2 server 232 with the highest resource utilization score can, in fact, handle load predicted for the new datacenter 140. Alternatively, in cases where cluster operator 280 determines that the HTTP/2 server 232 with the highest resource utilization score is unable to handle the load predicted for the new datacenter 140, cluster operator 280 may be configured to trigger the provisioning of a new HTTP/2 server 232 in public cloud 240 and assign the new datacenter 140 to the new HTTP/2 server 232 to initiate a connection. The resource utilization score determined by cluster operator 280 for each HTTP/2 server 232 may consider multiple utilization metrics (e.g., CPU utilization, memory utilization, throughput as a percentage of bandwidth, etc.), and different weights (e.g., coefficients) may be assigned to each of the different utilization metrics to determine at the best representation of each HTTP/2 server 232's runtime resource utilization. In some cases, a largest weight is assigned to a greatest value metric, while a smallest weight is assigned to a lowest value metric. Additional details regarding assigning a new datacenter 140 connection to an HTTP/2 server 232 are described below with respect to FIG. 3.

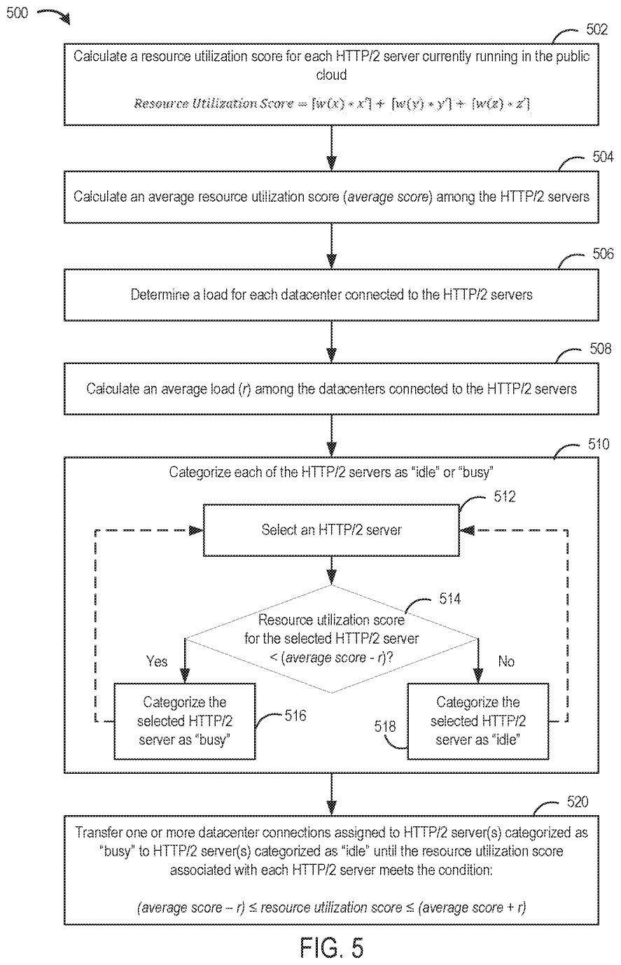

In addition to assigning datacenter 140 connections to various HTTP/2 servers 232, cluster operator 280 may also be configured to re-distribute load across HTTP/2 servers 232. More specifically, cluster operator 280 may be configured to re-balance datacenter 140 connections among a set (e.g., two or more) of existing HTTP/2 servers 232 to improve utilization of the existing infrastructure (e.g., existing pods 152 and their assigned resources). Improving resource utilization in Kubernetes cluster 150 helps to avoids unnecessarily provisioning additional resources (e.g., pods 152) in Kubernetes cluster 150 when new datacenter 140 connections are to be assigned. Additional details regarding the re-balancing of datacenter 140 connections is described below with respect to FIG. 5.

FIG. 3 illustrates an example workflow 300 for assigning a new datacenter connection to an HTTP/2 server, according to an example embodiment of the present disclosure. In certain embodiments, workflow 300 is performed by cluster operator 280 in FIG. 2 to assign new datacenter 140(9) to HTTP/2 server 232(1), HTTP/2 server 232(2), HTTP/2 server 232(3), HTTP/2 server 232(4), and/or to a new HTTP/2 server 232 that may be deployed in public cloud 240 in FIG. 2. Although not meant to be limiting to this particular example, workflow 300 is described below for this example scenario.

Workflow 300 begins, at step 302, by cluster operator 280 determining to establish a connection between new datacenter 140(9) and an HTTP/2 server in public cloud 240. The HTTP/2 server 232 may be an existing HTTP/2 server 232 running in public cloud 240, such as HTTP/2 server 232(1), HTTP/2 server 232(2), HTTP/2 server 232(3), or HTTP/2 server 232(4). Alternatively, the HTTP/2 server 232 may be a new (e.g., additional) server that cluster operator 280 triggers for deployment in public cloud 240 (e.g., thereby increasing the number of HTTP/2 servers 232 in public cloud 240).

Workflow 300 proceeds, at step 304, with cluster operator 280 calculating a resource utilization score for each HTTP/2 232 server currently running in public cloud 240. In this example, cluster operator 280 may calculate four resource utilization scores-one resource utilization score for each of HTTP/2 servers 232(1), 232(2), 232(3), and 232(4). Each resource utilization score may be calculated as:

$$Resource Utilization Score = [ w ( x ) * {x}^{′} ] + [ w ( y ) * {y}^{′} ] + [ w ( z ) * {z}^{′} ]$$

where x, y, and z are resource usage values for individual resource metrics, w(x), w(y), and w(z) are weights determined for each resource metric, respectively, and

$${x}^{′} = 100 - x \\ {y}^{′} = 100 - y \\ {z}^{′} = 100 - z$$

Weights, w(x), w(y), and w(z) may be calculated as:

$$w ( x ) = \frac{{x}^{( 1 + mx )}}{{x}^{( 1 + mx )} + {y}^{( 1 + my )} + {z}^{( 1 + mz )}} \\ w ( y ) = \frac{{y}^{( 1 + my )}}{{x}^{( 1 + mx )} + {y}^{( 1 + my )} + {z}^{( 1 + mz )}} \\ w ( z ) = \frac{{z}^{( 1 + mz )}}{{x}^{( 1 + mx )} + {y}^{( 1 + my )} + {z}^{( 1 + mz )}}$$

respectively, where

$$w ( x ) + w ( y ) + w ( z ) = 1$$

Further, variable m is a real number greater than zero and less than one. Variable m is a tuning parameter used to help ensure that w(x), w(y), and w(z) increase sharply as the value x, y, and z, respectively, become closer to one.

For this example scenario, x is a resource usage value representing CPU utilization (e.g., as a percentage (%) of CPU allocated) at an HTTP/2 server 232 for which a resource utilization score is being calculated for. Further, y is a resource usage value representing memory usage (e.g., as a percentage (%) of memory allocated), and z is a resource usage value representing throughput as a percentage (%) of bandwidth. In some other examples, resource usage values for less than three or more than three resource metrics may be used to calculate each resource utilization score (e.g., for each HTTP/2 server). Further, in some other examples, CPU utilization, memory usage, and/or throughput may or may not be used to calculate each resource utilization score, with or without other resource metrics.

Using the above calculations, a value of a weight may increase as a value of the corresponding resource metric increases. For example, a CPU utilization of 90% (e.g., x=90%) may be given a greater value weight (w(x)) than a CPU utilization of 20% (e.g., x=20%). Giving more weight to resource metrics with greater values (e.g., values closer to maximum usage of 100%) may, in turn, reduce the resource utilization score calculated for an HTTP/2 server 232.

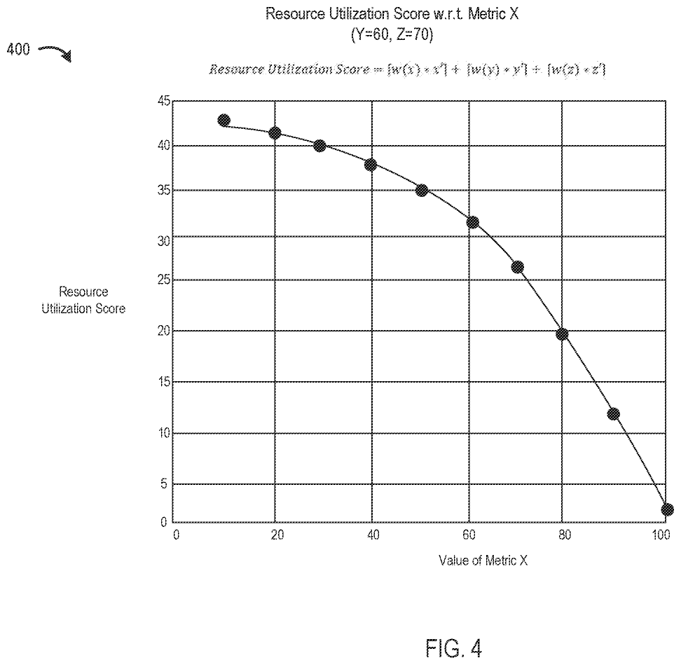

FIG. 4 is a graph 400 illustrating the relationship between a value of first resource metric (x) and the resource utilization score, according to an example embodiment of the present disclosure. Graph 400 includes an x-axis representing values of x between 0 and 100, where x=0 represents a case where 0% of a resource is being used at an HTTP/2 server 232 and x=100 represents a case where 100% of a resource is being used (e.g., maximum resource usage) at the HTTP/2 server 232. Further, graph 400 includes a y-axis representing resources utilization scores calculated for different values of x, while keeping other resource usage values for other resource metrics consistent (e.g., y=60 and z=70 for each resource utilization score calculation). As shown, as the value of x increases from approximately 15% to 100%, the resource utilization score exponentially decreases.

In certain embodiments, the resource utilization score calculated for each HTTP/2 server is normalized between scores at a predefined maximum and minimum resource usage such that the resource utilization score is close to zero when the resource usage crosses a maximum allowed value. For example, as shown in FIG. 4, when x=100 (e.g., a resource usage is equal to a maximum allowed value for this resource metric) the resource utilization score is approximately equal to one or two; however, the resource utilization score is expected to be equal to zero. As such, for this example, each resource utilization score calculated for each HTTP/2 server 232 may be normalized by reducing each calculated score by one or two.

As an illustrative example of the resource utilization score calculation, it is assumed that the following resource utilization score is calculated for HTTP/2 server 232(1), which has a CPU utilization equal to 50%, a memory usage equal to 60%, and a throughput equal to 90%:

$$\begin{matrix}x = 50 & {x}^{′} = 100 - x = 50 \\ y = 60 & {y}^{′} = 100 - y = 40 \\ z = 90 & {x}^{′} = 100 - z = 10\end{matrix} \\ w ( x ) = \frac{{x}^{( 1 + mx )}}{{x}^{( 1 + mx )} + {y}^{( 1 + my )} + {z}^{( 1 + mz )}} = 0.176402 ( e . g . , where m = 3 ) \\ w ( y ) = \frac{{y}^{( 1 + my )}}{{x}^{( 1 + mx )} + {y}^{( 1 + my )} + {z}^{( 1 + mz )}} = 0.253738 ( e . g . , where m = 3 ) \\ w ( z ) = \frac{{z}^{( 1 + mz )}}{{x}^{( 1 + mx )} + {y}^{( 1 + my )} + {z}^{( 1 + mz )}} = 0.56986 ( e . g . , where m = 3 ) \\ \begin{matrix}Resource Utilization Score = [ w ( x ) * {x}^{′} ] + [ w ( y ) * {y}^{′} ] + [ w ( z ) * {z}^{′} ] \\ = [ 0.176402 * 50 ] + [ 0.253738 * 40 ] + \\ [ 0.56986 * 10 ] = 24.67\end{matrix}$$

Further, the following resource utilization score is calculated for HTTP/2 server 232(3), which has a CPU utilization equal to 20%, a memory usage equal to 30%, and a throughput equal to 20%:

$$\begin{matrix}x = 20 & {x}^{′} = 100 - x = 80 \\ y = 30 & {y}^{′} = 100 - y = 70 \\ z = 20 & {z}^{′} = 100 - z = 80\end{matrix} \\ w ( x ) = \frac{{x}^{( 1 + mx )}}{{x}^{( 1 + mx )} + {y}^{( 1 + my )} + {z}^{( 1 + mz )}} = 0.235977 ( e . g . , where m = 3 ) \\ w ( y ) = \frac{{y}^{( 1 + my )}}{{x}^{( 1 + mx )} + {y}^{( 1 + my )} + {z}^{( 1 + mz )}} = 0.528046 ( e . g . , where m = 3 ) \\ w ( z ) = \frac{{z}^{( 1 + mz )}}{{x}^{( 1 + mx )} + {y}^{( 1 + my )} + {z}^{( 1 + mz )}} = 0.235977 ( e . g . , where m = 3 ) \\ \begin{matrix}Resource Utilization Score = [ w ( x ) * {x}^{′} ] + [ w ( y ) * {y}^{′} ] + [ w ( z ) * {z}^{′} ] \\ = [ 0.235977 * 80 ] + [ 0.528046 * 70 ] + \\ [ 0.235977 * 80 ] = 74.72\end{matrix}$$

Similar calculations may be performed to calculate resource utilization scores for HTTP/2 server 232(2) and HTTP/2 server 232(4).

After calculating a resource utilization score for HTTP/2 servers 232(1)-(4) in public cloud 240, workflow 300 proceeds, at step 306, with cluster operator 280 identifying an HTTP/2 server having a highest resource utilization score among the resource utilization score calculated for HTTP/2 servers 232(1)-(4) currently running in public cloud 240. An HTTP/2 server 232 having a highest resource utilization score may have lower resource usage values for one or more resource metrics and/or may have only a minimal number of resource metrics, or none of their resource metrics, close to their maximum resource usage value (e.g., values of x, y, and/or z are not close to 100%).

In this example, cluster operator 280 may determine that HTTP/2 server 232(3) has a highest resource utilization score at 74.72 (e.g., per the example calculation above). Cluster operator 280 may determine that HTTP/2 server 232(3) is utilizing the least amount of allocated resources for serving existing connections between the server and datacenters 140 when compared to the other HTTP/2 servers 232(1), 232(2), and 232(4).

Workflow 300 then proceeds, at step 308, with cluster operator 280 determining whether HTTP/2 server 232(3) (e.g., having the highest resource utilization score) is able to handle load of (e.g., load predicted for) new datacenter 140(9). Cluster operator 280 may perform steps 310-316 to make this determination at step 308.

For example, at step 310, cluster operator 280 identifies one or more datacenters currently connected to HTTP/2 server 232(3) as datacenter 140(7) and datacenter 140(8). At step 312, cluster operator determines a current load for each datacenter (e.g., a load for datacenter 140(7) and a load for datacenter 140(8)). At step 314, cluster operator 280 calculates an average load among datacenter 140(7) and datacenter 140(8). The average load per datacenter 140 may be calculated as:

$$Average Load per Datacenter = \frac{Total Load of Datacenter ( s )}{Number of Datacenter ( s )}$$

At step 316, cluster operator 280 determines whether the resource utilization score calculated for HTTP/2 server 232(3) (e.g., Resource Utilization Score=74.72) is greater than a function of the average load per datacenter 140. For example, cluster operator 280 may determine whether the resource utilization score calculated for HTTP/2 server 232(3) is greater than a value equal to double the average load per datacenter 140 (e.g., the function of the average load per datacenter 140), or more specifically, whether:

$$Resource Utilization Score > 2 * Average Load per Datacenter$$

Comparing the resource utilization score to a value equal to double the average load per datacenter 140 provides a conservative comparison for verifying whether HTTP/2 server 232(3) is able to handle load of (e.g., load predicted for) new datacenter 140(9).

As shown at step 318 in workflow 300, if HTTP/2 server 232(3) is unable to handle the load of new datacenter 140(9) (e.g., Resource Utilization Score≤2*Average Load per Datacenter), then at steps 320 and 322, respectively, a new HTTP/2 server 232 is deployed in public cloud 240 (e.g., based on instructions from cluster operator 280) and a connection is established between new datacenter 140(9) and new HTTP/2 server 232. In other words, in this case, new resources may be provisioned to handle the new load (e.g., new datacenter 140(9)) because existing resources are unable to handle the new load.

Alternatively, if HTTP/2 server 232(3) is able to handle the load of new datacenter 140(9) (e.g., Resource Utilization Score>2*Average Load per Datacenter), then at step 324, a connection is established between new datacenter 140(9) and HTTP/2 server 232(3). In other words, in this case, existing resources are able to handle the new load (e.g., new datacenter 140(9)); thus, additional resources may not need to be provisioned.

As described above, often, due to asymmetric distribution of HTTP/2 server load one HTTP/2 server can face high resource usage, while resource usage of other HTTP/2 servers is relatively low. In such cases, some datacenters mapped to the heavily loaded HTTP/2 server must be redistributed among other HTTP/2 servers.

FIG. 5 illustrates an example workflow 500 for re-distributing load across HTTP/2 servers, according to an example embodiment of the present disclosure. In certain embodiments, workflow 500 is performed by cluster operator 280 in FIG. 2 to balance load (e.g., transactions over connections between each datacenter 140 and each HTTP/2 server 232) across HTTP/2 servers 232(1)-(4). Although not meant to be limiting to this particular example, workflow 500 is described below for this example scenario.

Workflow 500 begins, at step 502, with cluster operator 280 calculating a resource utilization score for each HTTP/2 server. The resource utilization score may be calculated using the same resource utilization score equation described above with respect to step 304 in FIG. 3. In this example, the resource utilization score calculated for HTTP/2 server 232(1) is equal to 90, the resource utilization score calculated for HTTP/2 server 232(2) is equal to 80, the resource utilization score calculated for HTTP/2 server 232(1) is equal to 30, and the resource utilization score calculated for HTTP/2 server 232(1) is equal to 20.

Workflow 500 proceeds, at step 504, with cluster operator 280 calculating an average resource utilization score (e.g., simply referred to herein as “average score”) among HTTP/2 servers 232(1)-(4). The average resource utilization score calculated for this example may be equal to 55 (e.g., (90+80+30+20)/4=55).

Workflow 500 proceeds, at step 506, with cluster operator 280 determining a load for each datacenter 140(1)-(8) (e.g., assuming a connection for datacenter 140(9) has not yet been assigned to an HTTP/2 server 232 in public cloud 240). For this example, cluster operator 280 determines eight loads, one for each datacenter 140(1)-(8). Further, at step 508, cluster operator 280 calculates an average load (r) among the eight datacenters 140 (1)-(8) connected to HTTP/2 servers 232(1)-(4).

Workflow 500 then proceeds, at step 510 with categorizing each of the HTTP/2 servers as “idle” or “busy.” Categorization at step 510 may include performing steps 512-518 illustrated in workflow 500. For example, at step 512, an HTTP/2 server 232 among the four HTTP/2 servers 232(1)-(4) is selected. Here, HTTP/2 server 232(1) may be selected at step 512. At step 514, cluster operator 280 determines whether the resource utilization score for HTTP/2 server 232(1) (e.g., determined at step 504) is less than the average score (e.g., determined at step 506) minus average load (r) (e.g., determined at step 508) (e.g., Resource Utilization Score<Average Score−r or Resource Utilization Score>Average Score−r).

If the resource utilization score for HTTP/2 server 232(1) is less than the average score minus average load (r) (e.g., Resource Utilization Score<Average Score−r) then, at step 516, cluster operator 280 categorizes HTTP/2 server 232(1) as “busy.” Alternatively, if the resource utilization score for HTTP/2 server 232(1) is not less than the average score minus average load (r) (e.g., Resource Utilization Score≥Average Score−r) then, at step 518, cluster operator 280 categorizes HTTP/2 server 232(1) as “idle.” Cluster operator 280 similarly repeats steps 512-518 for HTTP/2 server 232(2), HTTP/2 server 232(3), and HTTP/2 server 232(4) to categorize each of these servers, as well.

In this example, HTTP/2 server 232(1) (e.g., having a resource utilization score=90) and HTTP/2 server 232(2) (e.g. having a resource utilization score=80) may be categorized as “idle” servers. Further, HTTP/2 server 132(3) (e.g., having a resource utilization score=30) and HTTP/2 server 232(4) (e.g. having a resource utilization score=20) may be categorized as “busy” servers.

Workflow 500 proceeds, at step 520, with cluster operator 280 transferring one or more datacenter 140 connections assigned to HTTP/2 server(s) 232 categorized as “busy” to HTTP/2 server(s) categorized as “idle” until the resource utilization score associated with each HTTP/2 server 232 meets the condition:

(average score−r)<Resource Utilization Score<(average score+r)

In some cases, a bipartite graph representing movement of datacenter 140 connection(s) from one HTTP/2 server 232 to another is created (e.g., and used at step 512 in workflow 500). A bipartite graph is a graph whose vertices can be divided into two independent sets.

For the above example, the bipartite graph may represent movement of one or more datacenter 140 connections from HTTP/2 server 232(1) to HTTP/2 server 232(2) such that the resource utilization score of HTTP/2 server 232(1) is reduced by 35 and the resource utilization score of HTTP/2 server 232(4) is increased by 35. Additionally, the bipartite graph may represent movement of one or more datacenter 140 connections from HTTP/2 server 232(2) to HTTP/2 server 232(3) such that the resource utilization score of HTTP/2 server 232(2) is reduced by 25 and the resource utilization score of HTTP/2 server 232(3) is increased by 25. As such, after movement of one or more datacenter 140 connections, HTTP/2 server 232(1), HTTP/2 server 232(2), HTTP/2 server 232(3), and HTTP/2 server 232(4) may each have a resource utilization score equal to 55 (e.g., 90−35=55 for HTTP/2 server 232(1), 80−25=55 for HTTP/2 server 232 (2), 30+25=55 for HTTP/2 server 232 (3), and 20+35=55 for HTTP/2 server 232(4)).

HTTP/2 server 232(1) and HTTP/2 server 232(2) may be represented as vertices in the bipartite graph, and a connection between these two vertices, representing the decrease in the resource utilization score for HTTP/2 server 232(1) by 35 and the increase in the resource utilization score for HTTP/2 server 232(2) by 35, may be referred to as an “edge.” Thus, the weight of this edge (W) may be equal to 35.

To construct a bipartite graph and calculate the weight of different edges in the bipartite graph, one algorithm may include (1) calculating an average score per HTTP/2 server 232 (e.g., this is the target score for each HTTP/2 server 232) and (2) computing remaining capacity (R<HTTP/2 server>)=(Current score of HTTP/2 server)−(Average Score of HTTP/2 server). An HTTP/2 server 232 with a positive (R<HTTP/2 server>) may be considered as an “idle” HTTP/2 server while an HTTP/2 server 232 with a negative (R<HTTP/2 server>) may be considered as “busy” HTTP/2 servers. For a busy HTTP/2 server i, with remaining capacity (R<i>), the algorithm finds idle HTTP/2 servers j with remaining capacity (R<j>). A directed edge (m), or simply “edge,” is added from busy HTTP/2 server i to idle HTTP/2 server j, denoting a transfer of score, with the value of edge (m)=min (Abs (R<i>), Abs (R<j>)). Remaining capacity (R<j>) of the idle HTTP/2 server j is decreased by m, while remaining capacity (R<i>) of the busy HTTP/2 server i is increased by m. These steps are repeated until the remaining score for all HTTP/2 servers is equal to zero.

The load redistribution techniques described with respect to FIG. 5, and the above algorithm, may be similar to techniques for debt redistribution. For example, for a debt redistribution problem, a first task is to find out creditors and debtors for each individual transaction. For a load redistribution problem this may be achieved by finding an average resource utilization score for one or more of the HTTP/2 servers 232 based on the current resource utilization score calculated for each of HTTP/2 servers 232. HTTP/2 servers 232 with higher resource utilization scores than the average score may be treated as “debtors,” while HTTP/2 servers 232 with lower resource utilization scores than average score may be treated as “creditors.” Datacenter 140 connection(s) may be moved from debtor(s) to creditor(s) to help reach a state of optimum resource usage across HTTP/2 servers 232.

In cases where an even distribution of load is achievable among HTTP/2 server 232, then the number of datacenter 140 connections to move for each edge in the bipartite graph (as described above) may be equal to:

$$Number of Datacenter Connections to Move = \frac{Weight of Edge}{Average Load per Datacenter}$$

where, as described above:

$$Average Load per Datacenter = \frac{Total Load of Datacenter ( s )}{Number of Datacenter ( s )}$$

and Weight of Edge refers to the movement/flow of load from one HTTP/2 server 232 to another. Load is a complement of the calculated resource utilization score, such that Load=100−(Resource Utilization Score as a %). Alternatively, if the calculation is performed with a normalized value of one, then Load=1−(Resource Utilization Score).

In cases where the load per datacenter 140 varies significantly across HTTP/2 servers 232 then the above described-method of determining the number of datacenter connections to move, based on an average load per datacenter (e.g., denominator value in the equation above) may not be used. In particular, the above formula used to calculate the Number of Datacenter Connections to Move assumes that the load per datacenter 140 is close to the average load per datacenter.

Instead, a different method is used for load redistribution. In particular, the method reduces to finding a list of datacenters 140 whose load is closest to, but not greater than the weight of an edge of the graph. This may, however, be a variation of a subset sum problem (e.g., a decision problem to check for the presence of a subset that has sum of elements equal to a given number), which is classified as a non-deterministic polynomial-time (NP) hard (NP-hard) problem (e.g., generally impractical to perform by humans). As such, an alternative solution (e.g., that may be run in polynomial time) to determine the number of datacenter 140 connections that need to be moved includes steps of (1) considering a weight (W) of one edge in the bipartite graph, (2) sorting the datacenter 140 connections assigned to a busy HTTP/2 server 232 in descending order of load to create a sorted list, and (3) creating a final list (L) of datacenter 140 connections to move from a busy HTTP/2 server 232 to an idle HTTP/2 server 232 by adding datacenter 140 connections from the sorted list until a sum of load of datacenter 140 connections in the final list (L) is less than weight W. If adding a datacenter 140 connection from the sorted list to the final list (L) makes the sum of the load in the final list greater than W, then this datacenter 140 connection may be skipped and a next datacenter 140 connection in the sorted listed may be added to the final list (e.g., (load in L)+(load of new site)>W, then skip this datacenter 140 and move to the next or stop adding datacenters 140 to final list (L)).

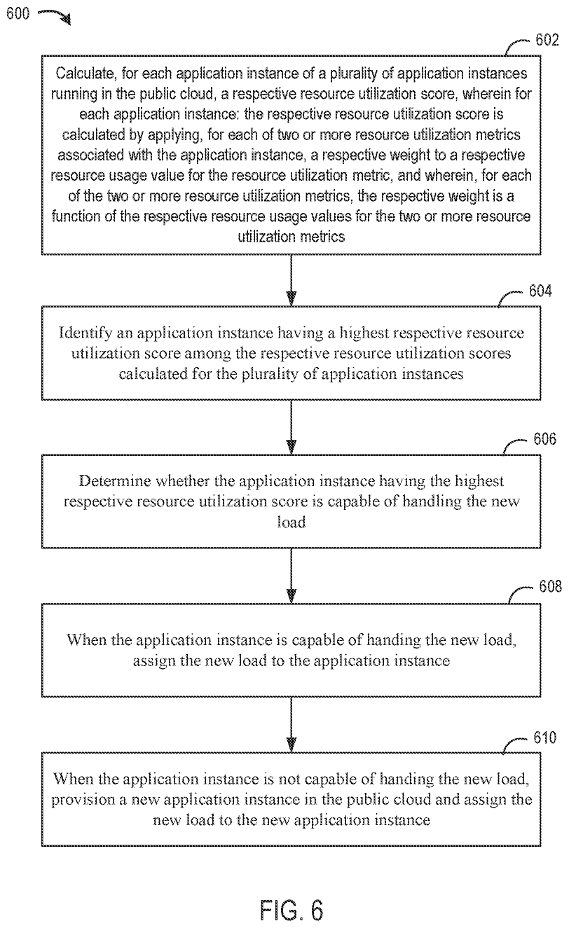

FIG. 6 illustrates an example method 600 for assigning new load to an application instance in a public cloud.

As illustrated in FIG. 6, method 600 begins, at step 602, with calculating, for each application instance of a plurality of application instances running in the public cloud, a respective resource utilization score. For each application instance: the respective resource utilization score is calculated by applying, for each of two or more resource utilization metrics associated with the application instance, a respective weight to a respective resource usage value for the resource utilization metric. For each of the two or more resource utilization metrics, the respective weight is a function of the respective resource usage values for the two or more resource utilization metrics.

Method 600 proceeds, at step 604, with identifying an application instance having a highest respective resource utilization score among the respective resource utilization scores calculated for the plurality of application instances.

Method 600 proceeds, at step 606, with determining whether the application instance having the highest respective resource utilization score is capable of handling the new load.

When the application instance is capable of handling the new load, method 600 proceeds, at step 608, with assigning the new load to the application instance.

Alternatively, when the application is not capable of handling the new load, method 600 proceeds, at step 610, with provisioning a new application instance in the public cloud; and assigning the new load to the new application instance.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)-CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for assigning new load to an application instance in a public cloud, the method comprising:
calculating, for each application instance of a plurality of application instances running in the public cloud, a respective resource utilization score, wherein for each application instance:
the respective resource utilization score is calculated by applying, for each of two or more resource utilization metrics associated with the application instance, a respective weight to a respective resource usage value for the resource utilization metric, and wherein, for each of the two or more resource utilization metrics, the respective weight is a function of the respective resource usage values for the two or more resource utilization metrics;
identifying an application instance having a highest respective resource utilization score among the respective resource utilization scores calculated for the plurality of application instances;
determining whether the application instance having the highest respective resource utilization score is capable of handling the new load;
when the application instance is capable of handing the new load:
assigning the new load to the application instance; and
when the application instance is not capable of handing the new load:
provisioning a new application instance in the public cloud; and
assigning the new load to the new application instance.

2. The method of claim 1, wherein, for each respective weight, the function of the respective resource usage values for the two or more resource utilization metrics comprises a first function of a first respective resource usage value divided by a second function of all the respective resource usage values.

3. The method of claim 1, wherein at least one respective weight applied to the respective resource usage value for one of the two or more resource utilization metrics is different than the respective weight applied to the respective resource usage value for another one of the two or more resource utilization metrics.

4. The method of claim 1, wherein the two or more resource utilization metrics comprise at least two or more of:
central processing unit (CPU) usage;
memory usage; or
throughput.

5. The method of claim 1, wherein determining whether the application instance having the highest respective resource utilization score is capable of handling the new load comprises:
determining a load for each datacenter connection associated with one or more datacenters connected to the application instance having the highest respective resource utilization score;
calculating an average load using the load determined for each datacenter connection associated with the one or more datacenters; and
determining whether the respective resource utilization score calculated for the application instance having the highest respective resource utilization score is greater than a function of the average load.

6. The method of claim 5, wherein the application instance is capable of handing the new load when the respective resource utilization score calculated for the application instance is greater than the function of the average load.

7. The method of claim 1, further comprising, prior to calculating, for each application instance of a plurality of application instances running in the public cloud, the respective resource utilization score:
re-assigning a datacenter connection assigned to a first application instance of the plurality of application instances to a second application instance of the plurality of application instances,
wherein re-assigning the datacenter connection from the first application instance to the second application instance:
reduces the respective resource usage value for at least one of two or more resource utilization metrics associated with the first application instance, and
increases the respective resource usage value for at least one of two or more resource utilization metrics associated with the second application instance.

8. The method of claim 1, wherein:
the new load comprises load for a connection that is to be established for a datacenter newly registered with a container-based cluster in the public cloud, and
the application instance comprises a Hypertext Transfer Protocol (HTTP)/2 server.

9. A system comprising:
one or more processors; and
at least one memory, the one or more processors and the at least one memory configured to:
calculate, for each application instance of a plurality of application instances running in a public cloud, a respective resource utilization score, wherein for each application instance:
the respective resource utilization score is calculated by applying, for each of two or more resource utilization metrics associated with the application instance, a respective weight to a respective resource usage value for the resource utilization metric, and wherein, for each of the two or more resource utilization metrics, the respective weight is a function of the respective resource usage values for the two or more resource utilization metrics;
identify an application instance having a highest respective resource utilization score among the respective resource utilization scores calculated for the plurality of application instances;
determine whether the application instance having the highest respective resource utilization score is capable of handling new load;
when the application instance is capable of handing the new load:
assign the new load to the application instance; and
when the application instance is not capable of handing the new load:
provision a new application instance in the public cloud; and
assign the new load to the new application instance.

10. The system of claim 9, wherein, for each respective weight, the function of the respective resource usage values for the two or more resource utilization metrics comprises a first function of a first respective resource usage value divided by a second function of all the respective resource usage values.

11. The system of claim 9, wherein at least one respective weight applied to the respective resource usage value for one of the two or more resource utilization metrics is different than the respective weight applied to the respective resource usage value for another one of the two or more resource utilization metrics.

12. The system of claim 9, wherein the two or more resource utilization metrics comprise at least two or more of:
central processing unit (CPU) usage;
memory usage; or
throughput.

13. The system of claim 9, wherein to determine whether the application instance having the highest respective resource utilization score is capable of handling the new load, the one or more processors and the at least one memory are configured to:
determine a load for each datacenter connection associated with one or more datacenters connected to the application instance having the highest respective resource utilization score;
calculate an average load using the load determined for each datacenter connection associated with the one or more datacenters; and
determine whether the respective resource utilization score calculated for the application instance having the highest respective resource utilization score is greater than a function of the average load.

14. The system of claim 13, wherein the application instance is capable of handing the new load when the respective resource utilization score calculated for the application instance is greater than the function of the average load.

15. The system of claim 9, wherein the one or more processors and the at least one memory are further configured to, prior to calculating, for each application instance of a plurality of application instances running in the public cloud, the respective resource utilization score:
re-assign a datacenter connection assigned to a first application instance of the plurality of application instances to a second application instance of the plurality of application instances,
wherein re-assigning the datacenter connection from the first application instance to the second application instance:
reduces the respective resource usage value for at least one of two or more resource utilization metrics associated with the first application instance, and
increases the respective resource usage value for at least one of two or more resource utilization metrics associated with the second application instance.

16. The system of claim 9, wherein:
the new load comprises load for a connection that is to be established for a datacenter newly registered with a container-based cluster in the public cloud, and
the application instance comprises a Hypertext Transfer Protocol (HTTP)/2 server.

17. A non-transitory computer-readable medium comprising instructions that, when executed by one or more processors of a computing system, cause the computing system to perform operations for assigning new load to an application instance in a public cloud, the operations comprising:
calculating, for each application instance of a plurality of application instances running in the public cloud, a respective resource utilization score, wherein for each application instance:
the respective resource utilization score is calculated by applying, for each of two or more resource utilization metrics associated with the application instance, a respective weight to a respective resource usage value for the resource utilization metric, and wherein, for each of the two or more resource utilization metrics, the respective weight is a function of the respective resource usage values for the two or more resource utilization metrics;
identifying an application instance having a highest respective resource utilization score among the respective resource utilization scores calculated for the plurality of application instances;
determining whether the application instance having the highest respective resource utilization score is capable of handling the new load;
when the application instance is capable of handing the new load:
assigning the new load to the application instance; and
when the application instance is not capable of handing the new load:
provisioning a new application instance in the public cloud; and
assigning the new load to the new application instance.

18. The non-transitory computer-readable medium of claim 17, wherein, for each respective weight, the function of the respective resource usage values for the two or more resource utilization metrics comprises a first function of a first respective resource usage value divided by a second function of all the respective resource usage values.

19. The non-transitory computer-readable medium of claim 17, wherein at least one respective weight applied to the respective resource usage value for one of the two or more resource utilization metrics is different than the respective weight applied to the respective resource usage value for another one of the two or more resource utilization metrics.

20. The non-transitory computer-readable medium of claim 17, wherein the two or more resource utilization metrics comprise at least two or more of:
central processing unit (CPU) usage;
memory usage; or
throughput.
